(19) United States
(12) Patent Application Publication
(10) Pub. No.: US 2011/0220628 A1
(43) Pub. Date: Sep. 15, 2011

(54) WIRE FEED MOTOR CONTROL SYSTEMS AND METHODS

(75) Inventor: Peter Donald Mehn, Oshkosh, WI (US)

(73) Assignee: Illinois Tool Works Inc., Glenview, IL (US)

(21) Appl. No.: 13/007,935

(22) Filed: Jan. 17, 2011

Related U.S. Application Data
(60) Provisional application No. 61/312,531, filed on Mar. 10, 2010.

(51) Int. Cl. B23K 9/10; B23K 9/26

(52) U.S. Cl. 219/130.1; 219/137.2; 219/137 R

(57) ABSTRACT

Wire feed drive assemblies having welding wire mounted thereon and a motor that rotates a wire feed roller to drive the weld wire toward a welding torch are provided. The wire feed drive assemblies also include a temperature sensor coupled to the motor and adapted to measure a temperature of the motor. The wire feed drive assemblies further include a motor controller coupled to the temperature sensor and the motor and adapted to receive temperature feedback from the temperature sensor and to utilize the temperature feedback to regulate a speed of the motor.

### CROSS REFERENCE TO RELATED APPLICATIONS

This application is a Non-Provisional Patent Application of U.S. Provisional Patent Application No. 61/312,531, entitled “Motor Temperature Estimator”, filed Mar. 10, 2010, which is herein incorporated by reference.

### BACKGROUND

The invention relates generally to welding systems, and, more particularly, to a wire feed drive system for use in a welding system.

Welding is a process that has become increasingly ubiquitous in various industries and applications. While such processes may be automated in certain contexts, a large number of applications continue to exist for manual welding operations. Such welding operations rely on a variety of types of equipment to ensure the supply of welding consumables (e.g., wire feed, shielding gas, etc.) is provided to the weld in an appropriate amount at the desired time. For example, metal inert gas (MIG) welding typically relies on a wire feeder to ensure a proper wire feed reaches a welding torch.

Such wire feeders typically facilitate the feeding of welding wire from a wire spool to the welding torch at a desired wire feed rate, which typically remains relatively constant throughout the welding operation. To that end, push-pull wire feeders have been developed that rely on a push motor and a pull motor to cooperatively operate to establish proper wire tension to drive the appropriate quantity of wire from the wire spool to the welding torch. Such systems are particularly useful when using aluminum based welding wires or other products that may lack the needed strength to resist column loading when pushed through the welding cable and, hence, are pushed from the wire feeder while being pulled by a motorized feed arrangement in the welding torch. However, the speed of each of the motors may vary during the wire feeding operation, often leading to undesirable variations in the wire feed rate. For example, during operation, as each of the motors generates operational heat, the speed of the motors may change (e.g., increase), thus affecting the wire feed rate, and possibly placing the welding wire under undesired stress. Such features limit the efficiency and utility of traditional wire feeders. Accordingly, there exists a need for wire feeder systems that overcome these drawbacks.

### BRIEF DESCRIPTION

In an exemplary embodiment, a welding system includes a welding power supply including power conversion circuitry adapted to receive primary power and to convert the primary power to a weld power output suitable for use in a welding operation. The welding system also includes a wire feeder including a wire spool, a push motor adapted to draw wire from the wire spool at a desired tension level, a first temperature sensor coupled to the push motor and adapted to measure a temperature of the push motor, and control circuitry adapted to receive temperature feedback from the temperature sensor. The wire feeder is adapted to receive one or more of power, gas, and control signals from the welding power supply. The welding system also includes a welding torch assembly including a pull motor adapted to establish a desired wire feed rate from the wire spool and a second temperature sensor coupled to the pull motor and adapted to monitor a temperature of the pull motor. The control circuitry of the wire feeder is adapted to receive temperature feedback from the second temperature sensor and to control operation of at least one of the push motor and the pull motor based on at least one of the feedback from the first temperature sensor and the feedback from the second temperature sensor.

In another embodiment, a wire feed drive assembly includes a wire spool including weld wire mounted thereon, a push motor adapted to rotate a wire feed roller to drive the weld wire from the wire spool toward a welding torch, and a temperature sensor coupled to the push motor and adapted to measure a temperature of the push motor. The wire feed drive assembly also includes a motor controller coupled to the temperature sensor and the push motor and adapted to receive temperature feedback from the temperature sensor and to utilize the temperature feedback to regulate a speed of the push motor.

In a further embodiment, a method of controlling a push-pull wire feed in a welding system includes determining an operational temperature of a motor adapted to rotate a wire feed roller to drive weld wire from a wire spool toward a welding torch, approximating one or more operational constants associated with the operation of the motor based on the determined operational temperature, and adjusting the value of one or more operational parameters associated with the motor to maintain a velocity of the motor at a desired value. The value of the one or more operational parameters is determined based on the operational temperature of the motor.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an exemplary welding system that powers, controls, and provides supplies to a welding operation in accordance with aspects of the present invention;

FIG. 2 is a block diagram illustrating components of an exemplary welding power supply, an exemplary wire feeder, and an exemplary welding torch assembly in accordance with embodiments of the present invention;

FIG. 3 illustrates an exemplary method that may be employed by an exemplary wire feeder controller to utilize motor temperature feedback to control a push-pull wire feeding operation in accordance with aspects of the present invention;

FIG. 4 illustrates an exemplary method that may be utilized by a motor controller to maintain a substantially constant motor speed throughout a welding operation in accordance with embodiments of the present invention; and

FIG. 5 illustrates an embodiment of an applied voltage versus motor speed plot in accordance with aspects of the present invention.

### DETAILED DESCRIPTION

As described in detail below, embodiments are described of a welding system including a speed control system configured to control a substantially uniform push-pull welding wire feed from a wire spool to a welding operation via a welding torch. Embodiments of the welding systems disclosed herein may include one or more temperature sensors associated with at least one of the push motor and the pull motor of the wire drive assemblies configured to feed the welding wire through the welding torch to the welding operation. A controller of the speed control system disposed, for example, in the welding wire feeder, receives feedback from the one or more temperature sensors and, based on such feedback, determines one or more temperature dependent constants. As such, the controller may utilize motor temperature feedback to adjust one or more parameters (e.g., a motor armature resistance value) of the wire feed operation to maintain the velocity of the push motor and/or the pull motor at a substantially fixed desired value. Accordingly, embodiments of the present invention may utilize motor temperature feedback to regulate a velocity or speed of one or more motors in a wire feed drive system. The foregoing feature may offer distinct advantages by enabling the wire feed speed at the welding torch to remain substantially stable throughout a welding operation even as the motors of the drive system heat up during use.

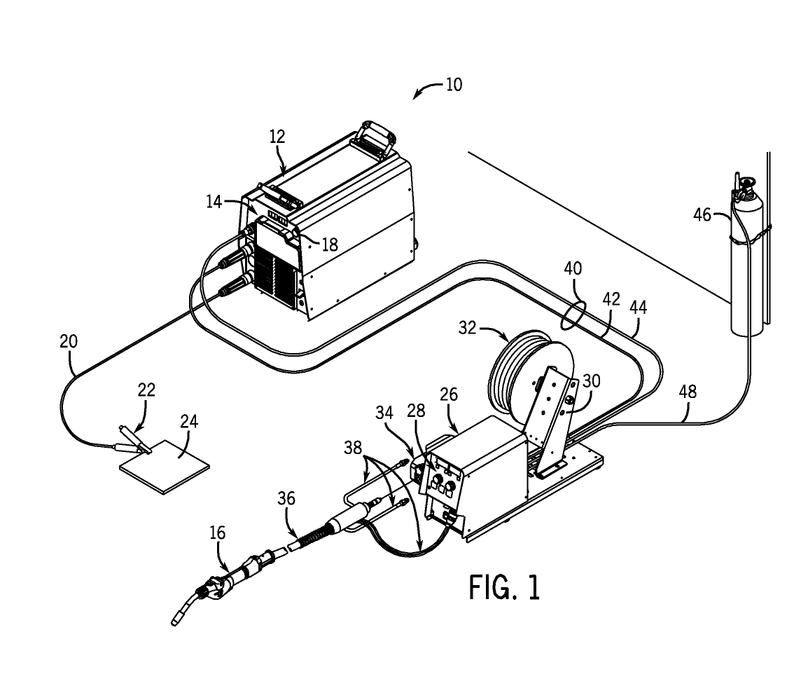

Turning now to the drawings, FIG. 1 illustrates an exemplary welding system 10 which powers, controls, and provides supplies to a welding operation. The welding system 10 includes a welder 12 having a control panel 14 through which a welding operator may control the supply of welding materials, such as gas flow, wire feed, and so forth, to a welding torch 16. To that end, the control panel 14 includes input or interface devices, such as knob 18 that the operator may use to adjust welding parameters (e.g., voltage, current, etc.). A work lead 20 couples the welder 12 to a work clamp 22 that connects to a workpiece 24 to complete the circuit between the welder 12 and the welding torch 16 during a welding operation.

The welding system 10 also includes a bench style wire feeder 26 that provides welding wire to the welding torch 16 for use in the welding operation. To that end, the wire feeder 26 of the illustrated embodiment includes a control panel 28 that allows the user to set one or more wire feed parameters, such as wire feed speed. The wire feeder 26 of the illustrated embodiment further includes a mounting structure 30 that is adapted to receive a wire spool 32. Additionally, the wire feeder 26 includes a wire feed drive assembly 34 configured to unspool the wire from the wire spool 32 to establish a feed of wire to the welding torch 16. The wire feeder 26 and the wire feed drive assembly 34 may house a variety of internal components, such as a motor, one or more drive rollers, and so forth, configured to cooperate to unspool the wire from the wire spool 32 in the desired manner as appropriate for the given operation. For example, in one embodiment, the wire feeder 26 may house a push motor coupled to a temperature sensor in the wire feed drive assembly 34. Further, such embodiments may include a controller disposed therein and coupled to the push motor and to the temperature sensor. The controller may be configured to monitor the detected temperature and to alter one or more control parameters of the motor to maintain an operating speed of the push motor at a substantially fixed value, as described in more detail below.

It should be noted that although the wire feeder 26 shown in the embodiment of FIG. 1 is a bench style feeder, in other embodiments, the wire feeder 26 may be any suitable wire feeder system, such as any of a variety of push-pull wire feeder systems, configured to utilize one or more motors to establish a wire feed to a welding torch. Indeed, embodiments of the present invention may be utilized in conjunction with motors of bench style feeders and/or non-bench style feeders, such as boom mounted style feeders and portable, suitcase-style wire feeders. Such wire feeders may be used with any wire feeding process, such as gas operations (gas metal arc welding (GMAW)) or gasless operations (shielded metal arc welding (SMAW)). For example, the wire feeders may be used in metal inert gas (MIG) welding or stick welding. Indeed, embodiments of the present invention include any welding wire feeder having a wire feed motor and a mechanism for acquiring or estimating feedback regarding the temperature of the motor during the welding operation.

In the illustrated embodiment, a variety of cables couple the components of the welding system 10 together and facilitate the supply of welding materials to the welding torch 16. A first cable 36, which may branch off into a variety of individual leads 38, couples the welding torch 16 to the wire feeder 26. A bundle 40 of cables couples the welder 12 to the wire feeder 26 and provides weld materials for use in the welding operation. The bundle 40 includes a power lead 42 and a control cable 44. It should be noted that the bundle 40 of cables may not be bundled together in some embodiments and/or may include additional data, power, or other suitable leads. Further, a gas cylinder 46, which is the source of the gas that supplies the welding torch 16, is coupled to the wire feeder 26 via gas conduit 48.

During operation of embodiments of the present invention, the components of the welding system 10 may cooperate to feed welding wire to the welding operation via the welding torch 16 via a push-pull feed system. To that end, in such embodiments, the welding torch 16 may house a pull motor configured to establish a wire feed rate to the welding operation, and the welding wire feeder 26 may house a push motor configured to draw the desired amount of wire from the welding spool 32 while maintaining an appropriate wire tension between the pull motor and the push motor. As such, the pull motor and the push motor may cooperate to maintain the desired wire feed from the wire spool 32 to the welding operation via the welding torch 16. To that end, as disclosed herein, one or both of such motors may be coupled to a temperature sensor, such as a thermistor, configured to monitor the temperature of the associated motor during the welding operation. Feedback regarding the operational temperature of one or both of the motors may be utilized by a controller to regulate the wire feed by regulating the speed of one or both of the motors, as described in more detail below.

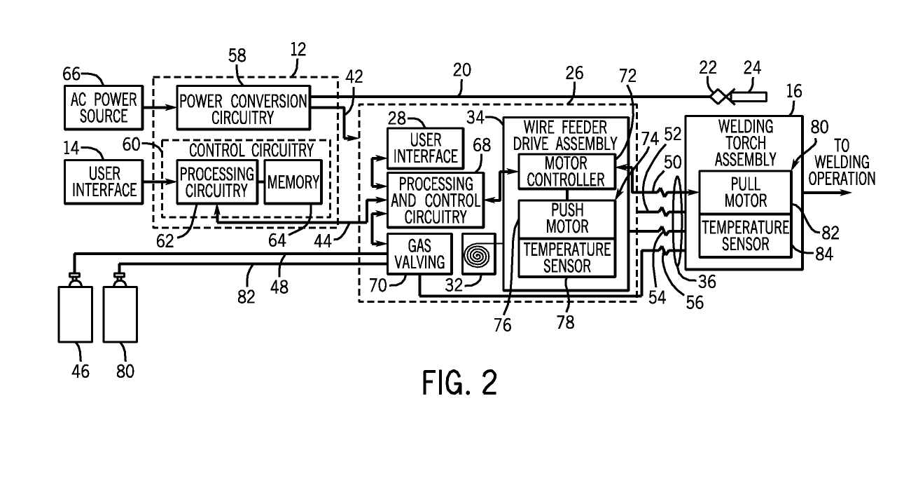

FIG. 2 is a block diagram illustrating internal components of the welder 12, the wire feeder 26, and the welding torch assembly 16 in accordance with an embodiment of the present invention. However, it should be noted that modifications to the illustrated system may be made in additional embodiments, and the illustrated embodiment is not meant to limit the system components. As before, the welder 12 and the wire feeder 26 are coupled to one another via power cable 42 and data cable 44, and the welding torch 16 is coupled to the wire feeder 26 via the bundle of cables 36. In the embodiment of FIG. 2, the bundle of cables 36 coupling the wire feeder 26 to the welding torch assembly 16 includes a data cable 50, a power cable 52, a wire feed lead 54, and a gas conduit 56.

In the illustrated embodiment, the welder 12 includes power conversion circuitry 58 and control circuitry 60. The control circuitry 60 includes processing circuitry 62 and associated memory 64. As illustrated, the processing circuitry 62 of the welder 12 interfaces with the operator interface 14 that allows for data settings to be selected by the operator. The operator interface 14 may allow for selection of settings such as the weld process, the type of wire to be used, voltage and current settings, and so forth. In particular, the system is designed to allow for MIG welding with aluminum or other welding wire that is both pushed towards the welding torch 16 and pulled through the torch 16 by a push motor and a pull motor, respectively.

During operation, the control circuitry 60 operates to control generation of welding power output that is applied to the welding wire for carrying out the desired welding operation. To that end, the control circuitry 60 is coupled to power conversion circuitry 58. The power conversion circuitry 58 is adapted to create the output power that will ultimately be applied to the welding wire at the welding torch 16. Various power conversion circuits may be employed, including choppers, boost circuitry, buck circuitry, inverters, converters, and so forth. The configuration of such circuitry may be of types generally known in the art. The power conversion circuitry 58 is coupled to a source of electrical power, for example AC power source 66. The power applied to the power conversion circuitry 58 may originate in the power grid, although other sources of power may also be used, such as power generated by an engine-driven generator, batteries, fuel cells or other alternative sources. Accordingly, when operated, the power conversion circuitry 58 and the control circuitry 60 of the welder 12 are configured to output power and data via cables 42 and 44, respectively, to the wire feeder 26 to control and power the welding operation at the welding torch 16.

The illustrated wire feeder 26 includes the user interface 28, processing and control circuitry 68, gas valving 70, the wire spool 32, and the wire feeder drive assembly 34. The wire feeder drive assembly 34 includes but is not limited to a motor controller 72 and a motor assembly 74. The motor assembly 74 includes a push motor 76 and a temperature sensor 78. The gas valving 70 is coupled to the first gas cylinder 46 via gas conduit 48 and to a second gas cylinder 80 via a second gas conduit 82.

During operation, the control circuitry 68 allows for wire feed speeds to be controlled in accordance with operator selections indicated via the user interface 28 and permits these settings to be fed back to the processing circuitry 62 of the power supply 12 via data conduit 44. For example, the operator interface 28 may allow for selection of such weld parameters as the process, the type of wire utilized, current, voltage or power settings, and so forth. The operator interface 28 may also allow the operator to choose a type of gas desired for the given application or the processing circuitry 68 may determine an appropriate gas type based on one or more operator selections. To that end, the control circuitry 68 is also coupled to the gas control valving 70, which regulates the flow of shielding gas to the welding torch 16 in accordance with the selections chosen by the operator. In general, such gas is provided at the time of welding and may be turned on immediately preceding the weld and for a short time following the weld.

During operation, the control circuitry 68 of the wire feeder 26 also controls components of the wire feeder drive assembly 34 that operate to feed wire to the welding torch 16. For example, in some embodiments, the feed of wire from the spool of welding wire 32 housed in the wire feeder 26 to the welding torch 16 may be controlled by the control circuitry 68 in conjunction with the motor controller 72. However, although in the illustrated embodiment, control circuitry 68 and motor controller 72 are illustrated as distinct components, in other embodiments, a single control circuit may be provided to coordinate operation of the wire feeder components. For instance, in one embodiment, the motor controller 72 may be integrated into the main control circuitry 68. Indeed, any of a variety of suitable control circuits may be utilized in the wire feeder 26 to implement the desired wire feed.

To establish a wire feed from the welding spool 32 to the welding torch 16, welding wire is unspooled from the spool 32 and is progressively fed to the torch 16 at a desired speed as established by the push motor 76. For example, the push motor 76 may engage with feed rollers to push wire from the wire feeder 26 towards the torch 16. In practice, one of the wire feed rollers is mechanically coupled to the push motor 76 and is rotated by the motor 76 to drive the wire from the wire feeder 26, while the mating roller is biased towards the wire to maintain good contact between the two rollers and the wire. Some systems may include multiple rollers of this type.

Such a wire feed process is controlled by the motor controller 72, which exhibits control over one or more operating parameters of the push motor 76. In accordance with embodiments of the present invention, the temperature sensor 78 is operated either continuously or periodically at desired intervals to measure the temperature of the push motor 76 throughout its operation. As such, the temperature sensor 78 may be coupled to the motor 76 in a variety of suitable ways. For example, in one embodiment, the temperature sensor 78 may be a thermistor attached to the chassis of the motor 76. Further, the temperature sensor 78 communicates the sensed measurements to the motor controller 72, which may alter control of the motor 76 based on the received feedback to maintain the operating speed of the motor 76 at a desired value throughout the welding operation, as described in more detail below. In such a way, embodiments of the present invention provide for directly measuring or indirectly predicting or estimating a temperature of the motor 76 and utilizing such data to control the operational speed of the motor.

In the illustrated embodiment, the wire feeder 26 is coupled to the welding torch assembly 16 via the bundle of cables 36 including the data lead 50, the power lead 52, the wire cable 54, and the gas conduit 56. The welding torch assembly 16 includes but is not limited to a motor assembly 80 including a pull motor 82 and a temperature sensor 84. During operation, the pull motor 82 operates one or more drive rolls to establish and maintain a desired wire feed rate, for example, as selected by an operator on interface 28 located on the wire feeder 26. Operation of the pull motor 82 may be controlled in any of a variety of suitable ways. For example, the motor controller 72 may control operation of the pull motor 82 via data conduit 50. In such embodiments, feedback from the temperature sensor 84 regarding the operational temperature of the pull motor 82 may be communicated to the motor controller. As before, the motor controller 72, alone or in conjunction with the control circuitry 68, may utilize the temperature feedback from the sensor 84 to control operation of the pull motor 82, for example, by controlling the speed of the motor 82, to maintain a substantially uniform push-pull wire feed to the welding operation.

In the illustrated embodiment, the push motor 76 is associated with temperature sensor 78, and the pull motor 82 is associated with temperature sensor 84. However, in presently contemplated embodiments, one or both of the push motor 76 and the pull motor 82 may be coupled to a temperature sensor. For example, in one embodiment, the push motor 76 may be coupled to a temperature sensor but the temperature of the pull motor 82 may not be measured or estimated. Still further, in some embodiments, a variety of suitable ways of measuring or estimating the temperature of one or both of the motors may be employed, not limited to utilizing a single temperature sensor. For instance, in one embodiment, a plurality of temperature sensors may be located on and around the push motor, and the feedback from the plurality of sensors may be utilized by the motor controller 72 to approximate a temperature of the motor and to utilize the approximated temperature to control the motor speed.

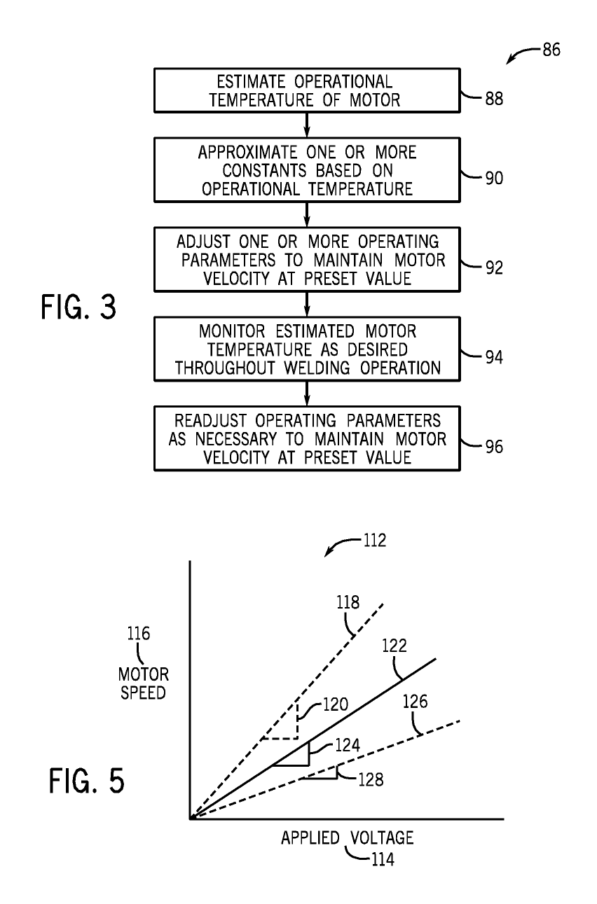

FIG. 3 illustrates a method 86 that may be employed by an exemplary wire feeder controller to utilize motor temperature feedback to control a wire feeding operation. The method 86 includes the step of estimating the operational temperature of a motor (block 88). For example, the controller may receive feedback from a temperature sensor located on the chassis of the push motor of the wire feeder. The method also includes approximating one or more constants that guide motor operation based on the estimated operational temperature (block 90) and adjusting one or more operating parameters of the motor to maintain the velocity of the motor at a preset value (block 92). Subsequently, throughout the welding operation, the estimated motor temperature may be monitored as desired (block 94), for example, continuously or at predefined intervals, and the operating parameters may be readjusted as necessary to maintain the motor velocity at the desired value (block 96).

For example, in one embodiment, the speed of a motor may be represented by the following equation:

V_{eff}=Kᵥ*Wₐᵣₘ=Vₜₑᵣₘ−(Iₐᵣₘ*Rₐᵣₘ), (1)

in which V_{eff} is the effective voltage applied to the motor, Kᵥ is the volts/revolutions per minute constant of the motor, Wₐᵣₘ is the angular velocity of the motor, Vₜₑᵣₘ is the applied terminal voltage of the motor, Iₐᵣₘ is the measured armature current in the motor, and Rₐᵣₘ, is the resistance of the motor's armature. It has been recognized that Rₐᵣₘ and Kᵥ are temperature dependent constants and, as such, may be determined based on the measured or estimated temperature of the motor. For example, after obtaining the motor temperature, the controller may determine such constants, for example, by utilizing an appropriate lookup table. Accordingly, by obtaining the motor temperature during the welding operation, the foregoing constants may be determined by the controller, and the remaining unknown parameters of equation 1 may be varied to maintain the velocity of the motor at the preset or desired value. As such, the method of FIG. 3 may enable embodiments of the presently disclosed motor controllers to correct motor velocity throughout the welding operation even as motor temperature varies during use. The foregoing feature may enable embodiments of the wire feed systems disclosed herein to maintain a substantially constant wire feed throughout a welding operation even as one or more motors of the wire drive system produce heat with use.

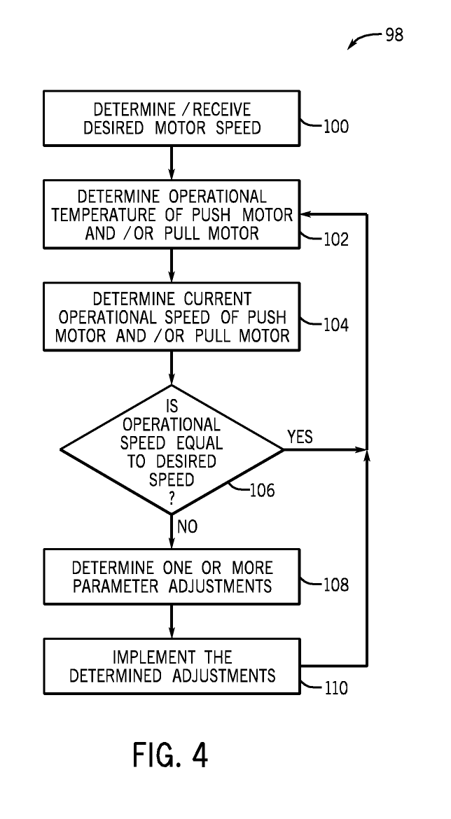

FIG. 4 illustrates a method 98 that may be utilized by the motor controller to maintain a substantially constant motor speed throughout a welding operation. The method includes determining or receiving a desired motor speed (block 100). For example, the desired motor speed may be determined based on one or more parameters or settings input by the welding operator. The method 98 also includes determining the operational temperature of the push motor and/or the pull motor (block 102) as before. Again, one or both of the motors shown in FIG. 2 may be associated with a temperature measurement device in accordance with the demands of the welding system. The method 98 also includes determining the current operational speed of the push motor and/or the pull motor (block 104).

The controller checks if the current operational speed of the one or more motors is equal to the desired speed of the considered motors (block 106) and, if so, the controller continues to monitor the temperature of the one or more motors. However, if the operational speed and the desired speed are different, the controller determines one or more desirable parameter adjustments (block 108). For example, the controller may utilize equation 1 to determine one or more desirable adjustments needed to alter the motor speed to achieve the desired value. The adjustments determined by the controller may then be implemented (block 110), and the controller continues to monitor the motor temperature and adjust one or more parameters to achieve the desired velocity in accordance with equation 1.

FIG. 5 illustrates an embodiment of an applied voltage versus motor speed plot 112 that may be utilized by the controller to achieve a desired motor speed. The plot 112 includes an applied voltage axis 114 and a motor speed axis 116. The plot 112 further includes a first profile 118 having a first slope 120, a second profile 122 having a second slope 124, and a third profile 126 having a third slope 128. As illustrated, the speed of the motor is directly correlated to the voltage applied to the motor. Therefore, throughout a welding operation, by varying the applied voltage, the motor controller may alter the motor speed to maintain the motor speed at the desired value. Further, as the motor in the welding torch heats up during operation, the slope 120, 124, or 128 of the operational voltage versus speed plot for the torch motor varies since the motor speed may increase with an increase in temperature. As such, the motor controller may alter a suitable parameter (e.g., the applied voltage) to counteract the heating effects during a welding operation in accordance with the methods disclosed herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding system, comprising:
a welding power supply comprising power conversion circuitry configured to receive primary power and to convert the primary power to a weld power output suitable for use in a welding operation;
a wire feeder comprising a wire spool, a push motor configured to draw wire from the wire spool, a first temperature sensor coupled to the push motor and configured to measure a temperature of the push motor, and control circuitry configured to receive temperature feedback from the temperature sensor, wherein the wire feeder is configured to receive one or more of power, gas, and control signals from the welding power supply; and
a welding torch assembly comprising a pull motor configured to establish a desired wire feed rate from the wire spool and a second temperature sensor coupled to the pull motor and configured to measure a temperature of the pull motor, wherein the control circuitry of the wire feeder is configured to receive temperature feedback from the second temperature sensor and to control operation of at least one of the push motor and the pull motor based on at least one of the feedback from the first temperature sensor and the feedback from the second temperature sensor.

2. The welding system of claim 1, wherein the control circuitry is configured to regulate a speed of the push motor to a desired speed based on the feedback received from the first temperature sensor.

3. The welding system of claim 1, wherein the control circuitry is configured to regulate a speed of the pull motor to a desired speed based on the feedback received from the second temperature sensor.

4. The welding system of claim 1, wherein the control circuitry is configured to control operation of the push motor by adjusting an armature resistance value of the push motor based on the received temperature feedback from the first temperature sensor.

5. The welding system of claim 1, wherein the wire feeder further comprises gas valving coupled to one or more gas cylinders and configured to regulate a gas flow from the one or more gas cylinders to the welding torch assembly.

6. The welding system of claim 1, wherein the welding power supply further comprises a controller configured to communicate with the control circuitry of the wire feeder to coordinate a wire feed from the welding spool to the welding torch assembly based on one or more selections made by an operator via a user interface.

7. A wire feed drive assembly, comprising:
a wire spool comprising weld wire mounted thereon;
a motor configured to rotate a wire feed roller to drive the weld wire from the wire spool toward a welding torch;
a temperature sensor coupled to the motor and configured to measure a temperature of the motor; and
a motor controller coupled to the temperature sensor and the motor and configured to receive temperature feedback from the temperature sensor and to utilize the temperature feedback to regulate a speed of the motor.

8. The wire feed drive assembly of claim 7, wherein the motor controller is configured to adjust an armature resistance value to regulate the speed of the motor.

9. The wire feed drive assembly of claim 7, wherein the motor controller is configured to adjust a voltage applied to the motor to regulate the speed of the motor.

10. The wire feed drive assembly of claim 7, further comprising a pull motor disposed in or on the welding torch and a temperature sensor coupled to the pull motor and configured to measure a temperature of the pull motor.

11. The wire feed drive assembly of claim 10, wherein the motor controller is coupled to the pull motor and to the temperature sensor and is configured to utilize temperature feedback from the temperature sensor to regulate a speed of the pull motor.

12. The wire feed drive assembly of claim 11, wherein the motor controller is configured to utilize the feedback from the temperature sensor associated with the motor and the temperature sensor associated with the pull motor to control operation of the motor and the pull motor to coordinate a substantially uniform wire feed rate of the wire from the spool to the welding torch.

13. The wire feed drive assembly of claim 7, wherein the motor controller is coupled to a main control circuit of a wire feeder and configured to exchange data with the main control circuit to control operation of the motor according to one or more operator inputs.

14. The wire feed drive assembly of claim 7, wherein the temperature sensor is a thermistor attached to the chassis of the motor.

15. A method of controlling a push-pull wire feed in a welding system, comprising:
determining an operational temperature of a motor configured to rotate a wire feed roller to drive weld wire from a wire spool toward a welding torch;
approximating one or more operational constants associated with the operation of the motor based on the determined operational temperature; and
adjusting the value of one or more operational parameters associated with the motor to maintain a velocity of the motor at a desired value, wherein the value of the one or more operational parameters is determined based on the operational temperature of the motor.

16. The method of claim 15, wherein determining an operational temperature of the motor comprises attaching a thermistor to the chassis of the motor and monitoring the measurement value of the thermistor.

17. The method of claim 15, wherein the operational constants comprise at least one of a volts per revolutions per minute constant of the motor and a resistance of the armature of the motor.

18. The method of claim 15, wherein determining an operational temperature of the motor comprises monitoring a temperature of an environment surrounding the motor and utilizing the monitored temperature to estimate a temperature of the motor.

19. The method of claim 15, wherein the operational parameter comprises a voltage applied to a terminal of the motor.

20. The method of claim 15, wherein the desired value of the velocity of the motor is determined based on operator input regarding a desired wire feed rate.
